(19) United States
(12) Patent Application Publication
(10) Pub. No.: US 2007/0166668 A1
(43) Pub. Date: Jul. 19, 2007

(54) Optical sighting device for small arms

(76) Inventor: Maximillian Kusz, Perrysburg, OH (US)

Correspondence Address: Maximillian Kusz, 9947 Sheffield Rd., Perrysburg, OH, 43551, US

(21) Appl. No.: 11/314,849

(22) Filed: Dec. 22, 2005

(51) Int. Cl. F41G 3/26; G09B 19/00

(52) U.S. Cl. 434/16

(57) ABSTRACT

This invention is a device for attachment to a firearm allowing the individual to remain under cover while extending the weapon to view the field of fire, aim the weapon, and fire the weapon. The device consists of a lens projecting an image onto an array capable of converting the image into a digital signal that is then conducted to a screen for viewing by the combatant holding the weapon.

### FIELD OF INVENTION

This invention relates to an optical device for aiming small arms such as rifles. When soldiers engaged in a fire fight under urban warfare conditions they will at times blind fire their weapon. That is, they at times may remain under cover while extending and firing their weapon without visual sighting of the intended target. A device that facilitated the aiming of a weapon without exposing the combatant to enemy fire would be a significant improvement over blind firing the weapon.

### BACKGROUND OF THE INVENTION

A combatant by nature and by training will minimize their exposure to enemy fire to avoid becoming a causality of the fire fight. One of the methods commonly utilized is to blind fire ones weapon while remaining under cover. That is, they at times may remain under cover while extending and firing their weapon in the general direction of the enemy without visual sighting of the intended target. The ability of one to hit a target without being able to aim ones weapon at the target is remote.

A patent issued to Hope U.S. Pat. No. 6,539,661 discloses a device attached to the telescopic optical sight for sighting along the barrel of a firearm. This invention is used for retaining an image of that seen in the telescopic sight when the trigger of the weapon is pulled.

A patent issued to Loving U.S. Pat. No. 5,103,567 discloses the use of a fiber optic bundle attached to a weapon with one end of the bundle being pointed at a target and the other end being accessible to the shooter for purposes of aiming the weapon. While this disclosure can function as intended for viewing a target without exposing ones self it lacks versatility. That is, it is difficult to simultaneously hold the fiber optic for viewing while rapidly aiming and firing the weapon.

### BRIEF SUMMARY OF THE INVENTION

This invention is a device installed on a weapon that is used in combat or simulated combat. While the concept disclosed is quite simple it is none the less unique and can be very effective when used for its intended purpose. To understand this disclosure one can visualize the digital cameras in common use. To use these cameras, one turns the camera on, aims it at a subject to be photographed, views the image on a small screen, adjusts the zoom, and snaps the picture. My invention positions a module containing optics, similar to those in the camera, on the barrel of a weapon. This module is wired to the remainder of the electronic components including the screen, located on or in the stock of the weapon. Preferably the screen would be attached to the electronics package and be located in the stock of a rifle. This package could then be installed in the stock such that the screen could be viewed on either the left or right side of the stock.

Now when the combatant having this weapon is behind cover as they are engaged in a fire fight they can turn this device on, extend the weapon pointed in the general direction of the enemy, view the screen and see the image of the field of fire where the weapon is aimed, and pull the trigger when the enemy is targeted. With practice one can remain under cover while they easily extend, aim, and fire the weapon in less that one second using the digital device disclosed. Further, the rapid advances in the electronics industry make this device not only effective but also relatively low cost. This device is the basis of this disclosure and one can intuitively determine its value in combat conditions.

The basic device can and should incorporate features that enhances its use and helps to protect it from the ambient conditions under which it could come under while being used in actual combat conditions. These features could include optical and digital zoom, a cross hair on the screen, a rechargeable battery, removable covers for the optic lens and screen, and an optional infrared light capability, just to name a few.

While this device is directed toward weapons used in actual combat situations it is not limited to same as one can anticipate it being incorporated into other weapons used for recreational or training purposes such as paint ball weapons.

### DESCRIPTION OF DRAWINGS

FIG. 1 is a side view of a weapon

FIG. 2 is a side view of the optical module

FIG. 3 is a front view of the optical module

### DETAILED DESCRIPTION OF THE INVENTION

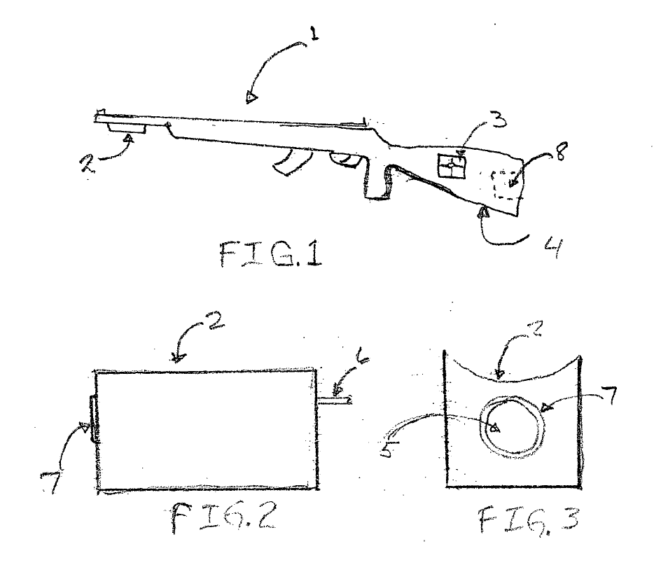

The device disclosed in this invention is shown in FIGS. 1-3. Specifically a weapon 1 has an optical module 2 attached to its barrel. This module has an aperture 7 containing a lens 5 at one end and a wire harness 6 at the other end. This wire harness connects the optical module 2 to the electronics module 8 contained in the stock of the weapon. The electronics module 8 contains a battery for supplying power to this device and connects to the LED screen 3 as well as the optical module 2 for the purpose of supplying power as well as electrical signals. These electrical signals include digital representations of the optical image obtained through lens 5, processed by the electronics module and conducted to the screen 3.

This device functions as follows: A visual image enters the optical module 2 through the lens 5 in aperture 7 and is converted to an electrical signal. This signal is conducted to the electronics module 8 in the stock 4 via wire harness 6. This signal is then conducted to the LED screen 3 where it can be viewed by the individual holding the weapon. The screen 3 is preferably combined with electronics package 8 with the screen remaining in the position shown in FIG. 1 with the electronics attached to and behind the screen. An enhancement to the optical module 2 could be one or more lens capable of being moved so as to magnify the incoming visual image. An alternate optical module 2 could contain sensors that would process infra-red rather than visual images, and conduct these images to the electronics module 8 for processing and conduction to the LED screen.

The electronics module 8 may also contain means for storing the visual image received by the optical module 2. The means for storing a digital image is well known in the art.

What I claim as my invention is:

1) A device for attachment to a firearm comprising an optical module, electronics module, and a screen,
said optical module being attached to said firearm,
said optical module having a lens for receiving light images,
said optical module having means for transforming said light images to a digital signal,
said optical module having one or more electrical connections to said electronics module,
said electronics module being attached to said firearm,
said electronics module having means for supplying power to said device,
said electronics module having means for receiving digital signals from said optical module and electrically transferring digital signals to said screen,
said screen having means for processing digital signals into a visual image,
said screen being attached to said fire arm.

2) A device according to claim 1 having said optical module being attached to the barrel of said firearm.

3) A device according to claim 1 having said optical module transform visual light images into digital signals.

4) A device according to claim 1 having said optical module transform infra-red light images into digital signals.

5) A device according to claim 1 having said optical module having one or more lens for variable magnification of light images received.

6) A device according to claim 1 having said optical module being combined with said electronics module into a single unit and being attached to said firearm.

7) A device according to claim 6 having said optical module combined with said electronics module into a single unit being attached to the barrel of said firearm and electrically conducting digital signals to said screen attached on or in said stock.

8) A device according to claim 1 having said electronics module combined with said screen into a single unit being attached on or in said stock.

9) A device according to claim 1 having said screen being composed of light emitting diodes.

10) A device according to claim 1 having said screen being composed of liquid crystals.

11) A device according to claim 1 being attached to a simulated firearm that emits relatively harmless projectiles and or light.
